(19) United States
(12) Patent Application Publication
(10) Pub. No.: US 2013/0046871 A1
(43) Pub. Date: Feb. 21, 2013

(54) MANAGING A PLURALITY OF ASSOCIATED MEDICAL DEVICES

(71) Applicants: Daniel Vik, La Jolla, CA (US); Sreelal Chandrasenan, San Diego, CA (US); Gregory Borges, San Diego, CA (US); Donald Halbert, San Diego, CA (US)

(72) Inventors: Daniel Vik, La Jolla, CA (US); Sreelal Chandrasenan, San Diego, CA (US); Gregory Borges, San Diego, CA (US); Donald Halbert, San Diego, CA (US)

(21) Appl. No.: 13/212,150

(22) Filed: Aug. 17, 2011

(51) Int. Cl. H04W 8/00; G06F 15/173

(52) U.S. Cl. 709/223

(57) ABSTRACT

A method for managing a plurality of associated medical devices. The method includes determining an association between a plurality of medical devices in a wireless network environment, and displaying a visual profile indicating the association between the plurality of medical devices.

### CROSS-REFERENCE TO RELATED U.S. APPLICATIONS

This Application is related to U.S. patent application Ser. No. 13/212,128, Attorney Docket Number CAFU-IRS110006US1, entitled, “ASSOCIATING A MEDICAL DEVICE WITH AN IDENTIFIER” by Vik et al., with filing date Aug. 17, 2011, and assigned to the assignee of the present application.

### BACKGROUND

Typically, medical devices are manually associated to a patient. The manual association is time consuming and also provides an opportunity for incorrect information, such as mistyping, to be provided to the medical device.

Also, there is no interaction between multiple single or multi-channel systems assigned to the same patient. The systems are configured individually and there is no coordination of information between the systems.

Moreover, there is no official indication that the multiple medical devices are, in fact, associated with one another. As a result, the workflow efficacy of a clinician, who manages the medical devices, may be decreased.

### BRIEF DESCRIPTION OF THE DRAWINGS

FIGS. 1 and 9 illustrate examples of a medical device, in accordance with an embodiment of the present invention.

FIGS. 2, 4, 5, 10 and 12 illustrate examples of a medical system environment, in accordance with embodiments of the present invention.

FIGS. 3, 6 and 7 illustrate examples of display information, in accordance with embodiments of the present invention.

FIG. 8 illustrates an example of method for associating a medical device with an identifier, in accordance with an embodiment of the present invention.

FIG. 11 illustrates an example of a method for managing a plurality of associated devices, in accordance with an embodiment of the present invention.

FIG. 13 illustrates an example of a method for visually recognizing associated medical devices, in accordance with an embodiment of the present invention.

The drawings referred to in this description should be understood as not being drawn to scale except if specifically noted.

### DESCRIPTION OF EMBODIMENTS

Reference will now be made in detail to embodiments of the present technology, examples of which are illustrated in the accompanying drawings. While the technology will be described in conjunction with various embodiment(s), it will be understood that they are not intended to limit the present technology to these embodiments. On the contrary, the present technology is intended to cover alternatives, modifications and equivalents, which may be included within the spirit and scope of the various embodiments as defined by the appended claims.

Furthermore, in the following description of embodiments, numerous specific details are set forth in order to provide a thorough understanding of the present technology. However, the present technology may be practiced without these specific details. In other instances, well known methods, procedures, components, and circuits have not been described in detail as not to unnecessarily obscure aspects of the present embodiments.

### Embodiments of Associating a Medical Device with an Identifier

The following discussion will first describe the components of medical device 110. Then the discussion will describe the functionality of the components during use of medical device 110.

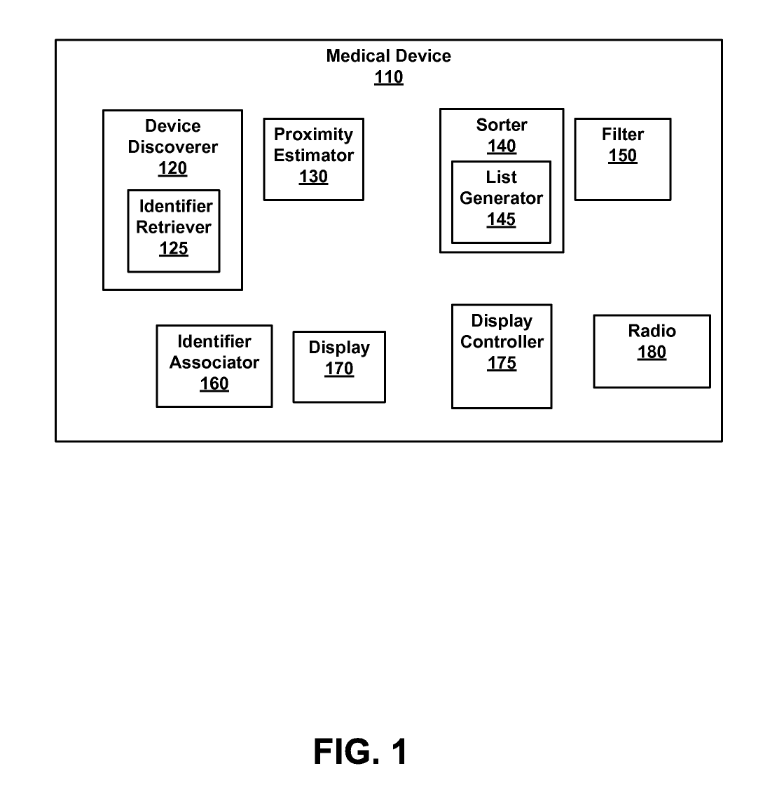

FIG. 1 depicts an embodiment of medical device 110. Medical device 110 is any medical device that is able to be associated with an identifier (e.g., patient identifier, patient area network identifier, etc).

Medical device 110 includes device discoverer 120, identifier retriever 125, proximity estimator 130, sorter 140, list generator 145, filter 150, identifier associator 160, display 170, display controller 175 and radio 180.

Device discoverer 120 is for discovering medical devices in a wireless network environment. Device discoverer 120 includes identifier retriever 125.

Identifier retriever 125 is for retrieving a variety of information associated with the discovered medical devices. For example, identifiers of the discovered medical devices in the wireless network environment, information for displaying/sorting device discrimination, device type, manufacturer, patient ID association, patient room, etc. It should be understood that any information retrieved by identifier retriever 125 is an identifier.

Proximity estimator 130 is for estimating the proximity between medical device 110 and other medical devices that are discovered by device discoverer 120.

Sorter 140 is for sorting the discovered medical devices and/or their respective identifiers. In one embodiment, sorter 140 sorts the discovered medical devices and/or their respective identifiers based on the proximity between medical device 110 and the discovered medical devices. For example, sorter 140 sorts the discovered medical devices and/or their respective identifiers into a list or table. In such an example, the discovered medical devices in the same room are sorted into a list or table.

Filter 150 is for filtering out one or more of an identifier and a discovered medical device. In one embodiment, filter 150 is for filtering out one or more of a subset of the identifiers and a subset of the discovered medical devices.

Identifier associator 160 is for associating medical device 110 with an identifier. In one embodiment, identifier associator 160 automatically associates medical device 110 with an identifier. In another embodiment, identifier associator 160 associates medical device 110 in response to a user selected identifier.

Display 170 is for displaying information associated with functional aspects of medical device 110 to a clinician. Display 170 can be any display that is able to display appropriate device and/or patient related information to a clinician.

Display controller 175 is for controlling display 170. In particular, display controller 175 is for controlling the viewing functionalities of the information displayed on display 170. For example, controlling the backlighting and/or contrast, and lists for user selection.

Radio 180 is for communicating with other medical devices. In one embodiment, radio 180 is a short range radio utilizing protocols, such as, but not limited to, Bluetooth, ZigBee, 802.11, RFID tags, etc.

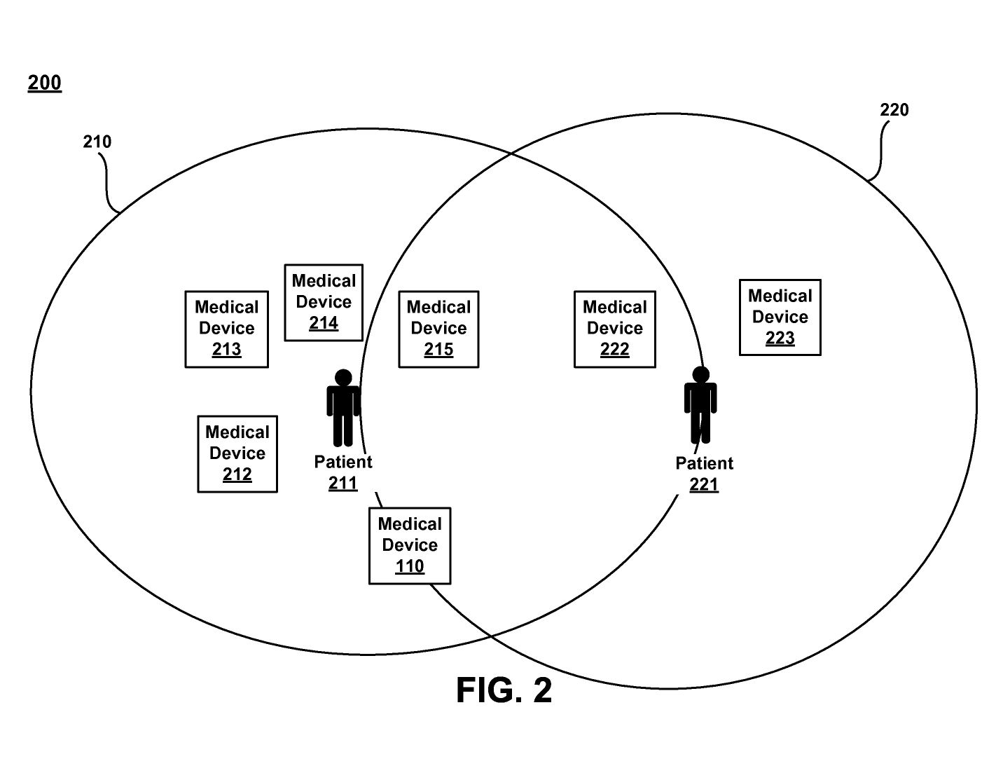

FIG. 2 illustrates an example of a medical system environment 200 (e.g., a wireless network environment). Medical system environment 200 includes a first patient area network that includes medical devices 212-215 that are associated with patient 211, and a second patient area network that includes medical devices 222 and 223 associated with patient 221. Accordingly, medical devices 212-215 are assigned to exclusively deliver care to patient 211, and medical devices 222 and 223 are assigned exclusively to deliver care to patient 221.

Medical devices 212-215 associated with patient 211 can be in close proximity to patient 211, for example, in the same room and next to the bed of patient 211. However, medical devices 212-215 can be in other areas that are not in the same room or next to the bed of patient 211. For example, one or all of medical devices 212-215 can be in another room or another part of the hospital.

Moreover, FIG. 2 depicts medical devices 212-215 associated with patient 211. However, it should be appreciated than any number of medical devices operating alone and/or in combination can be associated with patient 211.

Medical devices 222 and 223 associated with patient 221 can be in close proximity to patient 221, for example, in the same room and next to the bed of patient 221. However, medical devices 222 and 223 can be in other areas that are not in the same room or next to the bed of patient 221. For example, one or all of medical devices 222 and 223 can be in another room or another part of the hospital.

Moreover, FIG. 2 depicts medical devices 222 and 223 associated with patient 221. However, it should be appreciated than any number of medical devices operating alone and/or in combination can be associated with patient 211.

Medical devices 212-215, 222 and 223 can be any medical device for the care and/or monitoring of patients. Medical devices 212-215, 222 and 223 can be, but are not limited to, respirators, vital sign monitors, medication delivery systems, etc.

Medical devices 212-215, 222 and 223 include wireless connectivity to enable data sharing between the devices. Each medical device is configured with information, such as a patient identification or name. Other information can include, but is not limited to, device type or class, universal identifier, manufacturer, association capabilities and configurations and the like. As such, the information (e.g., patient identifier) can be shared with other devices within connectivity reach. Moreover, the information provides a logical grouping for the medical devices associated to the respective patient.

The wireless connectivity can occur due to a short range radio to allow the medical devices to discover and communicate with other devices that are located within a short distance. Accordingly, medical device 110 is able to discover and communicate with the medical devices, which will be described in detail below.

Referring to FIGS. 1 and 2, medical device 110 is a medical device that is not initially associated with patient 211 for the support and care of patient 211. It is a goal for medical device 110 to be associated with the first patient area network that includes medical devices 212-215 and not be associated with medical devices 222 and 223 that are associated with patient 221. Medical devices 212-215 in the first patient area network have a connectivity reach depicted by area 210. Similarly, medical devices 222 and 223 have a connectivity reach depicted by the area 220.

To initiate being associated with patient 211, medical device 110 utilizes device discoverer 120 to discover all of the devices within proximity to patient 211. Additionally, identifier retriever 125 retrieves the identifiers of the discovered medical devices.

In one embodiment, device discoverer 120 of medical device 110 discovers medical devices 212-215, 222 and 223. In particular, medical device 110 scans the devices within area 210 via radio 180 and device discoverer 120 subsequently discovers medical devices 212-215, 222 and 223.

Moreover, identifier receiver 125 receives the identifiers of each discovered medical device. For example, identifier receiver 125 receives an identifier (e.g., patient ID of patient 211) associated with medical devices 212-215 and an identifier (e.g., patient ID of patient 221) associated with medical devices 222 and 223.

Proximity estimator 130 estimates the proximity of discovered medical devices 212-215, 222 and 223 based on proximity measurements. In one embodiment, proximity estimator 130 estimates the proximity of discovered medical devices 212-215, 222 and 223 based on signal strength between medical device 110 and medical devices 212-215, 222 and 223. In such an embodiment, the medical devices that are closer to medical device 110 have a stronger signal.

For example, radio 180 is a radio and proximity estimator 130 estimates the proximity based on the signal strength between medical device 110 and discovered medical devices 212-215, 222 and 223. As such, the signal strength between medical device 212 is stronger than the signal strength of medical device 222, because medical device 212 is closer to medical device 110 than medical device 222.

Medical device 110 is able to determine or estimate proximity with discovered medical devices in a variety of ways. For instance, medical device 110 utilizes locating means such as, but not limited to, asset location, room based location (e.g., via RFID), local wired or wireless networks and global position system (GPS).

Sorter 140 sorts the discovered medical devices and respective identifiers before the information is presented to the clinician via display 170. In one embodiment, sorter 140 sorts the identifiers and discovered medical devices 212-215, 222 and 223 based on proximity (or other criteria) between medical devices 212-215, 222 and 223 and medical device 110 (which is still unassociated with patient 211).

In another embodiment, sorter 140 sorts the discovered medical devices 212-215, 222 and 223 and their respective identifiers based signal strength. Accordingly, list generator 145 generates a sorted list, such that medical devices (or device clusters) having a high signal strength are viewed before medical devices (or device clusters) with a lower signal strength. Moreover, patient identifiers retrieved from medical devices close to the medical device 110 can be displayed on top of the list. Additionally, the list can be further truncated so that patients located further way than a configured threshold are removed from the list and not displayed to the clinician.

In a further embodiment, sorter 140 utilizes the means of connectivity to facilitate in sorting. For example, list generator 145 generates a sorted list, such that medical devices utilizing short range radios are viewed before medical devices utilizing other connectivity means.

In various embodiments, sorter 140 is configured to sort discovered medical devices based on various information (e.g., any information collected during discovery, device classes and type, room number, asset location, clinical state, etc.). Moreover, additional information (e.g., care area) may be presented to a user to facilitate in sorting.

Table 1 below depicts an embodiment of a list or table generated by list generator 145.

| | | Proximity |
|---|---|---|
| Device | Identifier | Estimate |
| Medical Device 214 | Patient 211 | 35 |
| Medical Device 215 | Patient 211 | 40 |
| Medical Device 222 | Patient 221 | 30 |
| Medical Device 213 | Patient 211 | 30 |
| Medical Device 223 | Patient 221 | 20 |
| Medical Device 212 | Patient 211 | 35 |

Filter 150 filters out one or more of identifiers and discovered medical devices. In particular, filter 150 narrows down the list based on other characteristics, such as care area, room number, device type (e.g., clusters that include infusion devices), manufacturer, patient associations, clinician associations, devices that can be connected to other infusion systems, etc.

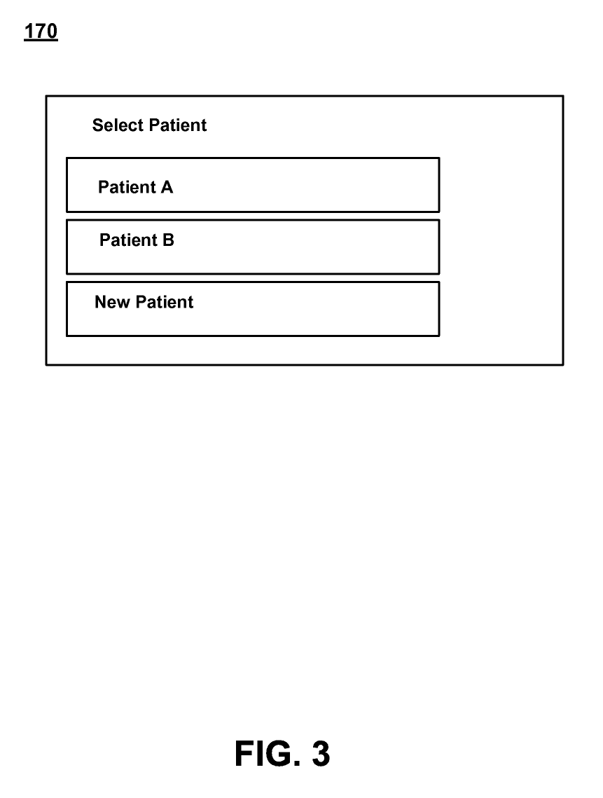

FIG. 3 depicts an embodiment of a list of information displayed to a clinician on display 170. As the list of patients can be based on distance to the medical device, the clinician is presented with a manageable number of possible patients to which a new medical device may be associated.

According to the information described in Table 1, “Patient A” (e.g., patient 211) is displayed ahead of or before “Patient B” (e.g., patient 221). Accordingly, a clinician would select the identifier “Patient A,” such that medical device 110 is associated with the identifier for patient 211.

In response to the selection of “Patient A,” identifier associator 160 associates medical device with the identifier for patient 211. Therefore, medical device 110 is associated with medical devices 212-215 and is not associated with medical devices 222 and 223 that are associated with patient 221.

In one embodiment, display 170 includes an option to manually create an association identifier. The manual creation can be facilitated by human interface devices (HID), such as a keyboard, touchscreen, knob, etc. In one example, inputs, such as bar code, can be enabled when the screen showing the patient ids allows the clinician to use the bar code without explicitly pressing a button.

In the case where medical device 110 is already configured with a patient identifier, medical device 110 may be automatically associated with a patient area network without displaying a “Select Patient” dialog, as depicted in FIG. 3.

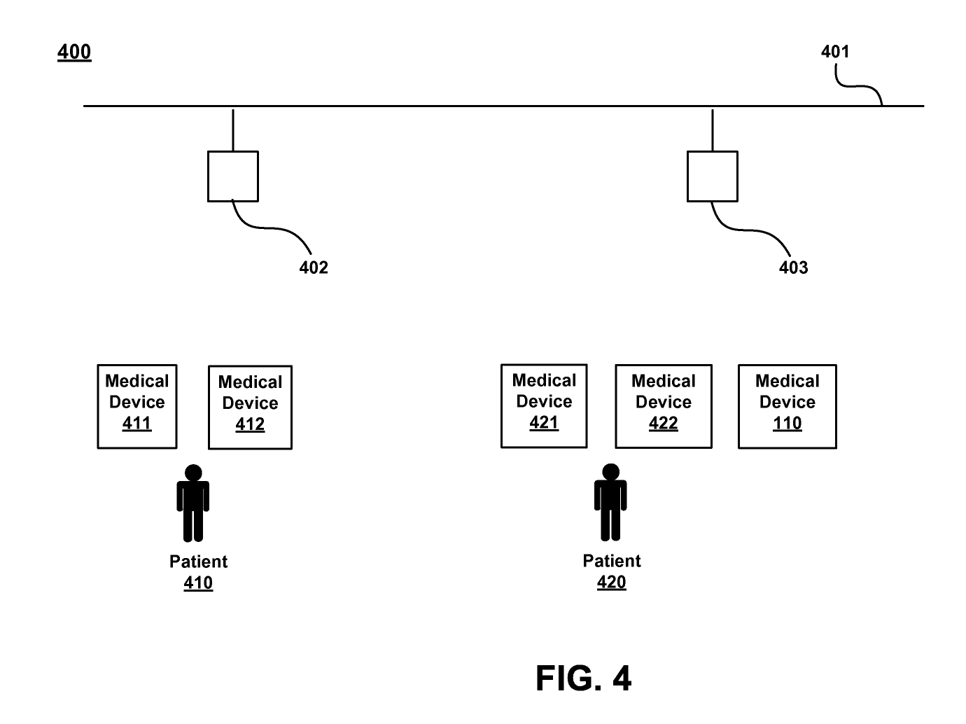

FIG. 4 depicts an embodiment of a medical system environment 400 that utilizes GPS to determine the proximity between medical device 110 and medical devices 411, 412, 421 and 422 and then share the information over LAN 401.

Each medical device includes a GPS (not shown). Each medical device communicates its location via a GPS to wireless access points 402 and/or 403.

To initiate being associated with patient 420, medical device 110 utilizes device discoverer 120 to discover all of the devices within proximity to medical device 110 via LAN 401. Additionally, identifier retriever 125 retrieves the identifiers of the discovered medical devices.

Medical device 110 then creates a list of patient identifiers based on the results from the discovery, removes devices that are not located in the near proximity to medical device 110 and then presents the list of remaining patient identifiers to the clinician in the same fashion as described above. For example, patient 420 is displayed at the top of a list based on the proximity of devices associated with patient 420.

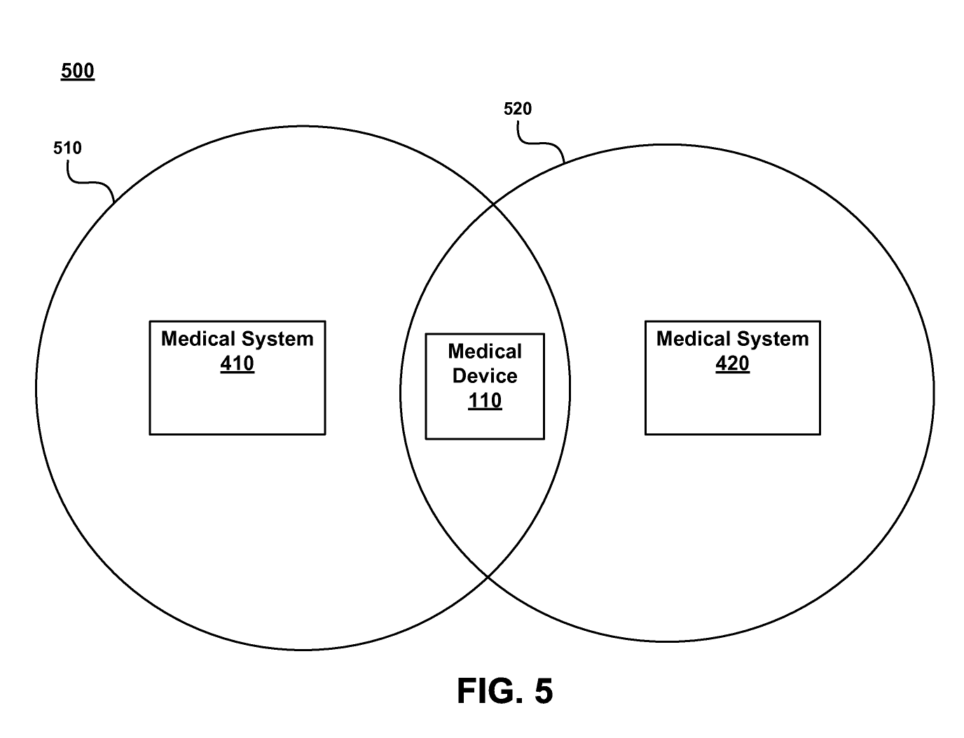

FIG. 5 illustrates an example of a medical system environment 500. Medical system environment 500 includes medical systems 511 and 521. Medical system 511 is closely coupled cluster of medical devices, such as, wirelessly equipped infusion pumps. Similarly, medical system 521 is a closely coupled cluster of medical devices, such as, wirelessly equipped infusion pumps.

Medical systems 511 and 521 each have a unique identifier. As such, each medical device of medical system 511 has the same unique identifier. Likewise, each medical device of medical system 521 has the same unique identifier.

Medical devices in medical system 511 have a connectivity reach depicted by area 510. Similarly, medical devices in medical system 521 have a connectivity reach depicted by the area 520.

In various embodiments, medical systems 511 and 521 include medical devices with specific functions. For example, medical systems 511 and 521 each include a plurality of devices such, but not limited to, wirelessly equipped stand alone infusion channels forming a multi-channel infusion system. In such an example, medical systems 511 and 521 each include a plurality of syringe devices, LVP devices, control units, etc.

Medical device 110 is a medical device to be associated with medical system 511. For example, medical device 110 is an additional LVP device for use by medical system 511.

Accordingly, medical device 110 utilizes device discoverer 120 to discover all of the devices within proximity. Additionally, identifier retriever 125 retrieves the identifiers of the discovered medical devices.

Medical device 110 then creates a list of identifiers based on the results from the discovery, removes devices and/or systems that are not located in the near proximity to medical device 110 and then presents the list of remaining identifiers to the clinician in the same fashion as described above.

Table 2 below depicts an embodiment of a list or table generated by list generator 145 with respect to medical system environment 500.

| | | Proximity |
|---|---|---|
| Device | Identifier | Estimate |
| Syringe Device 1 | Infusion System A | 45 |
| LVP Device 1 | Infusion System A | 40 |
| Optional Control Unit 1 | Infusion System A | 35 |
| LVP Device 2 | Infusion System B | 30 |
| LVP Device 3 | Infusion System B | 30 |
| Optional Control Unit 1 | Infusion System B | 35 |

It should be appreciated that Infusion System A corresponds to medical system 511 and Infusion System B corresponds to medical system 521.

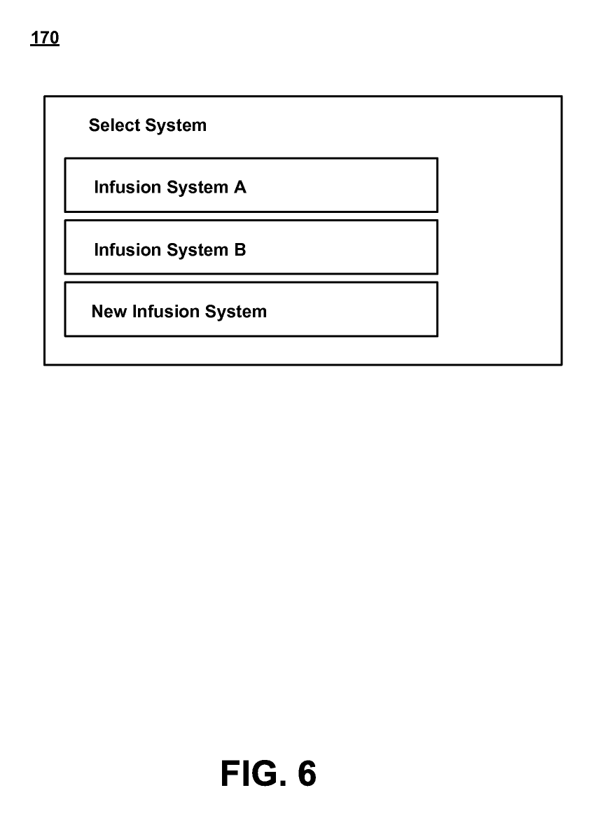

FIG. 6 depicts an embodiment of a list of information displayed to a clinician on display 170. As the list of devices can be based on distance to medical device 110, the clinician is presented with a manageable number of possible infusion systems to which medical device 110 is to be associated.

According to the information described in Table 2, “Infusion System A” is displayed ahead of or before “Infusion System B.” Accordingly, a clinician would select the identifier “Infusion System A,” such that medical device 110 is associated with the identifier for medical system 511.

In response to the selection of “Infusion System A,” identifier associator 160 associates medical device 110 with the identifier for medical system 511. Therefore, medical device 110 is associated with medical system 511.

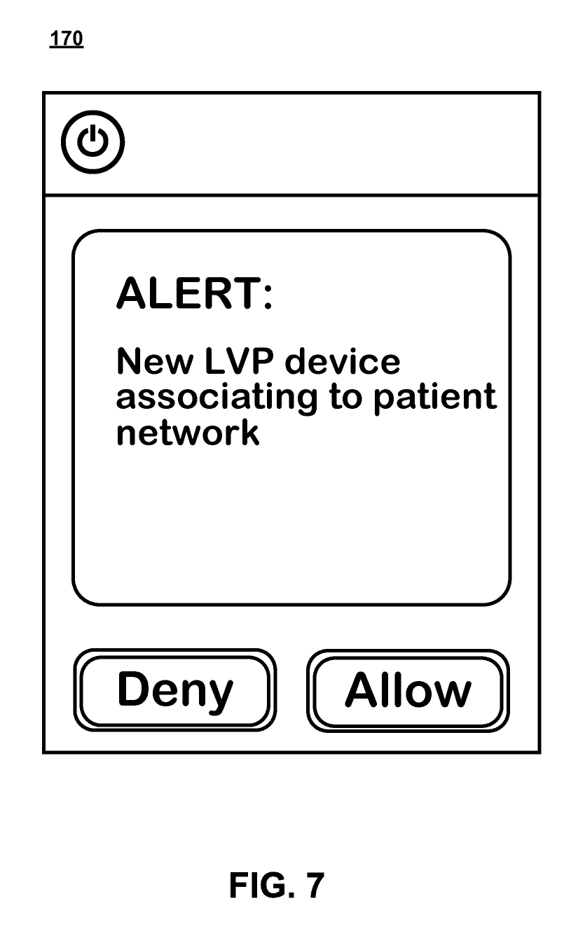

The same discovery methods, as described above, are utilized for medical systems (e.g., infusion pumps) that do not have local user interface capabilities for presenting a list of device clusters to a clinician. When a new device enters the cluster, a device with user interface capabilities already in the cluster (e.g., a central programming unit) is utilized to inform the clinician that a new device is ready to be added to the cluster. The clinician would then not be presented with a list of clusters, but instead presented with a screen showing that new device is available to join the cluster, as depicted in FIG. 7.

FIG. 7 depicts an embodiment of information displayed to a clinician. In particular, an alert is provided to a clinician on display 170, in response to a medical device (e.g. an LVP device) becoming available to join a device cluster.

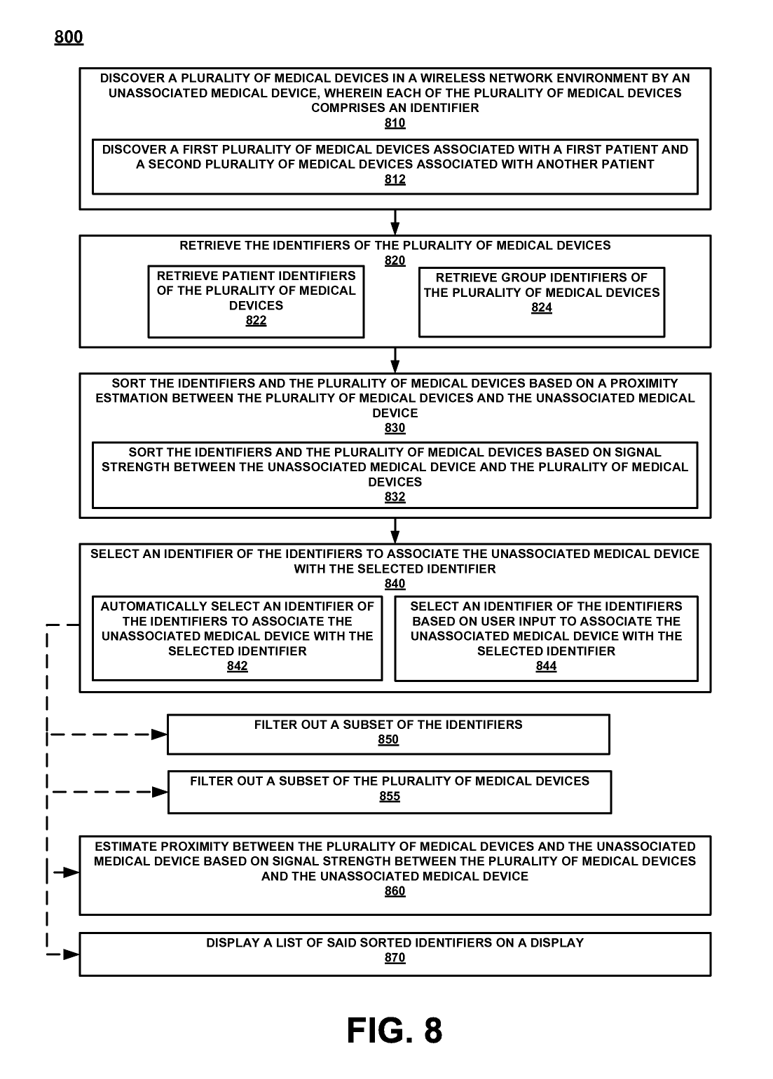

FIG. 8 depicts an embodiment of a method 800 for associating a medical device with an identifier. In various embodiments, method 800 is carried out by processors and electrical components under the control of computer readable and computer executable instructions. The computer readable and computer executable instructions reside, for example, in a data storage medium such as computer usable volatile and non-volatile memory. However, the computer readable and computer executable instructions may reside in any type of computer readable storage medium. In some embodiments, method 800 is performed at least by medical device 110, as described in FIG. 1.

At 810, a plurality of medical devices are discovered in a wireless network environment by an unassociated medical device, wherein each of the plurality of medical devices comprises an identifier. For example, medical devices 212-215, 222 and 223 are discovered by medical device 110, wherein the medical devices each comprise a patient identifier.

In one embodiment, at 812, a first plurality of medical devices associated with a first patient and a second plurality of medical devices associated with another patient are discovered. For example, medical devices 212-215 associated with patient 211 are discovered and medical devices 222 and 223 associated with patient 221 are discovered.

At 820, the identifiers of the plurality of medical devices are retrieved. In one embodiment, at 822, patient identifiers of the plurality of medical devices are retrieved. For example, patient identifiers of medical devices 212-215, 222 and 223 are retrieved.

In another embodiment, at 824, group identifiers of the plurality of medical devices are retrieved. For example, group identifiers for medical systems 511 and 521 are retrieved.

At 830, the identifiers and the plurality of medical devices are sorted based on a proximity estimation between the plurality of medical devices and the unassociated medical device. For example, identifiers and/or medical devices are sorted based on proximity between medical devices 411, 411, 421 and medical device 110. The proximity is determined by GPS coordinates of the medical devices.

In one embodiment, at 832, the identifiers and the plurality of medical devices are sorted based on signal strength between the unassociated medical device and the plurality of medical devices. For example, identifiers and/or the medical devices are sorted based on signal strength between medical device 110 and medical devices associated with medical systems 511 and 521.

At 840, an identifier of the identifiers is selected to associate the unassociated medical device with the selected identifier. For example, a clinician selects Patient A (as depicted in FIG. 3). Accordingly, medical device 110 is associated with Patient A.

In one embodiment, at 842, an identifier of the identifiers is automatically selected to associate the unassociated medical device with the selected identifier. For example, if only one patient area network is discovered, then identifier associator 160 automatically associates medical device 110 with the identifier of the patient area network.

In another embodiment, at 844, an identifier of the identifiers is selected based on user input to associate the unassociated medical device with the selected identifier. For example, a clinician selects identifier Infusion System A (as depicted in FIG. 6) on display 170 such that medical device 110 is associated with the identifier.

In one embodiment, at 850, a subset of the identifiers is filtered out. For example, a subset of identifiers filtered out based on characteristics such as care area (e.g., ICU).

In another embodiment, at 855, a subset of the plurality of medical devices is filtered out. For example, a subset or medical devices are filtered out based on characteristics such as device type (e.g., ventilators).

In another embodiment, at 860, proximity between the plurality of medical devices and the unassociated medical device is estimated based on signal strength between the plurality of medical devices and the unassociated medical device.

In a further embodiment, at 870, a list of the sorted identifiers are displayed on a display. For example, sorted identifiers of Patient A and Patient B are displayed on display 170, as depicted in FIG. 3.

### Embodiments of Managing a Plurality of Associated Medical Devices

In conventional systems, there is no official indication that multiple medical devices are, in fact, associated with one another in a cluster. A clinician may guess that there is a device cluster based on proximity of devices or visual inspection of wires connected between the devices. Additionally, a tag or the like may be utilized to demarcate a device cluster. As a result of no official indication of a device cluster, the work flow of a clinician may be affected.

Accordingly, the following discussion will describe management of device clusters. More particularly, presenting a visual indication of a device cluster, as well as, states of devices in the device cluster. Thus, the clinician work flow and safety is improved.

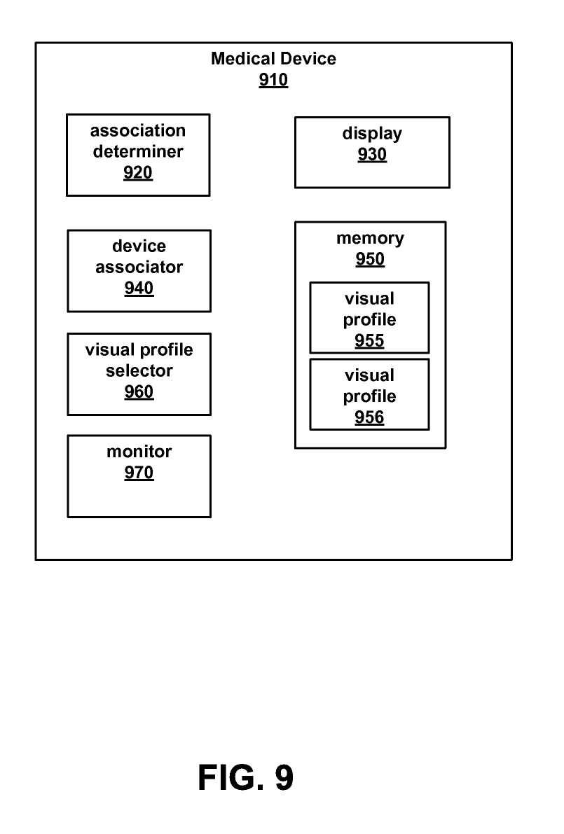

FIG. 9 depicts an embodiment of medical device 910. Medical device 910 includes association determiner 920, display 930, device associator 940, memory 950, visual profile selector 960 and monitor 970. Medical device 910 can be similar to medical device 110. Also, in various embodiments, medical device 910 can include any of the components of medical device 110, which are described in detail above.

Association determiner 920 is configured for determining an association between a plurality of medical devices in a wireless network environment. In other words, association determiner 920 is configured for determining whether medical devices are in a device cluster or device group.

Display 930 is configured for displaying a visual profile indicating the association between the plurality of medical devices. Display 930 can be any component that allows for visual indication of the association between the plurality of medical devices. Display 930 can be, but is not limited to, a light emitting diode (LED), a cathode ray tube (CRT) screen, liquid-crystal display (LCD), and the like. In one embodiment, display 930 is similar to display 170.

It should be appreciated that display 930 can be integrated in medical device 910 or be physically separate from medical device 910.

Device associator 940 is configured for facilitating in the association between the plurality of medical devices. In one embodiment, device associator 940 is further configured for generating the plurality of medical devices in response to user input. In another embodiment, device associator 940 is further configured for automatically generating the association between the plurality of medical devices.

It should be appreciated that association determiner 920, device associator 940, memory 950 (or any component that facilitates in allowing for visual indication of a group cluster) can be disposed anywhere in a medical system environment, such as server (not shown).

In various embodiments, device 910 can include a group configuration module that stores group configuration data for group identification, filtering or sorting and cluster maintenance. The group configuration module can take input from one or more of a group definition module.

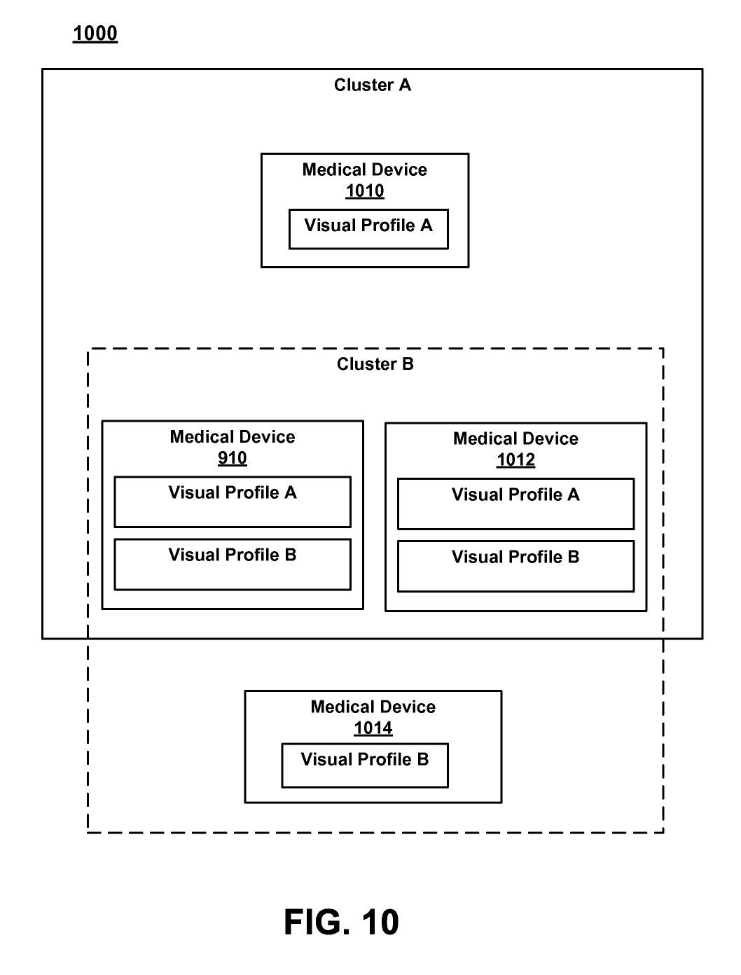

FIG. 10 depicts an embodiment of medical system environment 1000 (e.g., a wireless network environment). Medical system environment 1000 includes clusters of medical devices (e.g., Cluster A and Cluster B). A cluster or group of devices are any devices that are associated with one another. For example, Cluster A is a group of devices associated with one another.

A cluster can be defined in a variety of ways. For example, a cluster can be based on patient ID, device class (e.g., infusion devices, monitoring devices), device number/labels, room number, clinically relevant grouping (e.g., patient-controlled analgesia (PCA), monitoring device, and a computing tablet).

Additionally, a device can participate in multiple independent clusters simultaneously. For example, a device can be in an infusion cluster and a Barcode Medication Administration (BCMA) cluster.

In particular, Cluster A includes medical device 910, 1010 and 1012. Cluster B includes medical device 910, 1012 and 1014. It should be appreciated that any number of clusters can include any number of devices.

For clarity and brevity, the discussion below will focus on medical device 910. However, it is understood that other medical devices in medical system environment 1000 may be similar to medical device 910, in that they include components similar to the components of medical device 910 for facilitating in visually identifying to which patient area network or device cluster the medical device is assigned to.

During use of medical system environment 1000, association determiner 920 determines whether or not there is an association between devices in medical system environment 1000. As depicted in FIG. 10, it is determined that medical device 910 is associated with medical devices 1010 and 1012 in Cluster A. Additionally, it is determined that medical device 910 is also associated with medical devices 1012 and 1014 in Cluster B.

Generating or forming of clusters can be achieved in a variety ways. In various embodiments, device associator 940 generates the association of medical devices to form a cluster. In other embodiments, a cluster of devices is generated by means other than device associator 940. It should be appreciated that association determiner 920 determines whether or not there is an association between devices in medical system environment 1000, regardless of how the cluster is generated.

In one embodiment, clusters are formed according to associating a medical device with an identifier, as described above.

In another embodiment, clusters are formed through device configuration information. The device configuration can be provided locally from storage or memory (e.g., memory 950) or from remote health management systems.

In a further embodiment, clusters are formed in response to user input. For example, a clinician manually selects and establishes a cluster via a user interface. In another example, a cluster is formed by initiating association on one device and the selecting participating devices. In a further example, a cluster is formed by initiating an association from a device with a selected color profile and selecting participating devices using the color profile, which will be described in greater detail below.

In another embodiment, clusters are formed based on device states or aggregated device states (e.g., infusion completed or pump alarm).

Clusters can be configured remotely from external devices. Also, clusters can be generated by discovering devices, as described in detail above.

In response to determination of a device cluster, a visual profile indicating the device cluster is displayed. For example, in response to medical device 910 being a part of Cluster A, display 930 displays Visual Profile A. Similarly, medical devices 1010 and 1012 also display Visual Profile A.

Likewise, in response to medical device 910 being a part of Cluster B, Visual Profile B is displayed. Similarly, medical devices 1012 and 1014 also display Visual Profile B.

In one embodiment, the visual profile is presented or displayed by one or more LEDs. For example, all the devices in a Cluster A have one or more LEDs that emit light to indicate that they are a part of Cluster A. It should be appreciated that the one or more LEDs can be any color and emit light in any pattern.

In such an example, visual profile selector 960 selects a visual profile 955 (e.g., Visual Profile A). The visual profile indicates the pattern of light emitted by the one or more LEDs.

In another embodiment, the visual indication is displayed by display 930. For example, visual profile 955 is displayed on display 930 as a visual indication that medical device 910 is in Cluster B. Similarly, visual profile 955 is displayed on medical devices 1012 and 1014 as a visual indication that the devices are also in Cluster B.

In various embodiments, the visual profiles can be, but are not limited to, color, text, pattern, bitmap, theme, icon, dynamic visualization (e.g., pop-up, dedicated visual page or list).

The visual profiles can be preloaded into memory 950 or any other storage. The visual profiles can also be created or modified before or during use of a medical system environment. In other words, the visual profiles can be configured. As a result, the displayed visual indication is configured.

The visual profiles can be configured by various means. For example, a user can configure or modify the color, text, pattern, bitmap, theme, icon, dynamic visualization (e.g., pop-up, dedicated visual page or list).

If a change of state of a cluster is detected, then a visual profile indicating the change is displayed. For example, if a new device is added to a Cluster A, then the presently displayed visual indication is modified or changed to visually indicate the addition of another medical device.

In another example, if the state of a device(s) changes, then the presently displayed visual indication is modified or changed to visually indicate the change of state of the device(s). In such an example, monitor 970 detects that state of device 910 has changed (or any other devices). As a result, the visual profile dynamically changes from blue to green, or text is presented that states that a change in state has occurred.

A state of a device can be, but is not limited to an alarm or any clinical significant event.

It should be appreciated that a cluster can be dissolved at any time. In various embodiments, a cluster can be dissolved based on user request, completion of clinician function, cluster dissolvement or dissolution request from other devices or external systems, information from the configuration, etc.

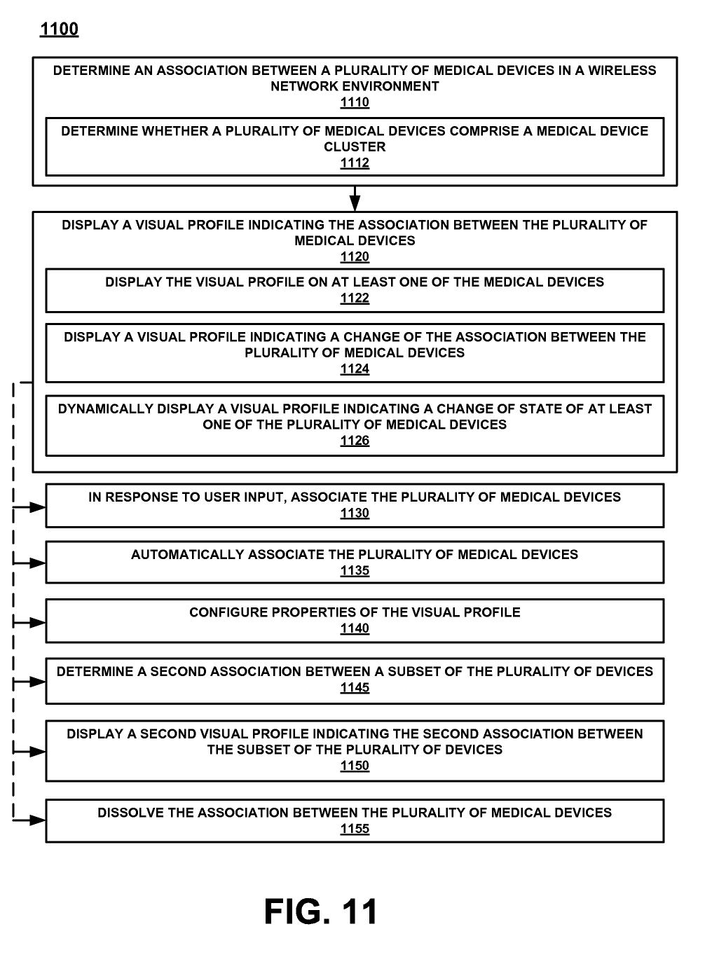

FIG. 11 depicts an embodiment of a method 1100 for managing a plurality of associated medical devices. In various embodiments, method 1100 is carried out by processors and electrical components under the control of computer readable and computer executable instructions. The computer readable and computer executable instructions reside, for example, in a data storage medium such as computer usable volatile and non-volatile memory. However, the computer readable and computer executable instructions may reside in any type of computer readable storage medium. In some embodiments, method 1100 is performed at least by medical device 910, as described in FIGS. 9 and 10.

At 1110 of method 1100, an association between a plurality of medical devices in a wireless network environment is determined. For example, association determiner 920 determines that medical devices 910, 1012 and 1014 are associated together based on a patient room number or device class (e.g., infusion pump devices).

In one embodiment, at 1112, it is determined that a plurality of medical devices comprise a medical device cluster. For example, association determiner 920 determines that medical devices 910, 1012 and 1014 comprise Cluster B.

At 1120, a visual profile indicating the association between the plurality of medical devices is displayed. For example, Visual Profile A is displayed to visually indicate that medical devices 910, 1010 and 1012 are in Cluster A.

In one embodiment, at 1120, the visual profile is displayed on at least one of the medical devices. For example, Visual Profile A is displayed on medical devices 910, 1010 and 1012 and Visual Profile B is displayed on medical devices 910, 1012, and 1014.

In another embodiment, at 1124, a visual profile indicating a change of the association between the plurality of medical devices is displayed. For example, if a new device is inserted into Cluster A, then a visual profile is displayed to indicate the new device. For instance, text is displayed that a new device is a part of Cluster A.

In a further embodiment, at 1126, a visual profile indicating a change of state of at least one of the plurality of medical devices is dynamically displayed. For example, if an alarm, of device 910, is initiated, then a visual profile is displayed indicating that the alarm, of device 910, is initiated. For instance, the initial visual profile is modified to include a flashing red background to indicate that the alarm is initiated.

At 1130, in response to user input, associating the plurality of medical devices. For example, device associator 940 creates Cluster A in response to user input at device 910.

At 1135, the plurality of medical devices are automatically associated. For example, device associator 940 automatically associates medical devices 910, 1010 and 1012 into Cluster A based on the medical devices having the same device class (e.g., infusion pump devices).

At 1140, the properties of the visual profiles are configured. For example, visual profile 955 is initially text. However, visual profile 955 can be configured, for example by a clinician, to also include a picture of the clinician and/or patient.

At 1145, a second association between a subset of the plurality of devices is determined. For example, medical devices 910 and 1012 (which are a subset of Cluster A) are determined to be associated with one another in Cluster B.

At 1150, display a second visual profile indicating the second association between the subset of the plurality of devices. For example, Visual Profile B is displayed to visually indicate devices associated with Cluster B.

At 1155, the association between the plurality of medical devices is dissolved. For example, Cluster A is dissolved, upon clinician request, such that medical devices 910, 1010 and 1012 are no longer associated with one another.

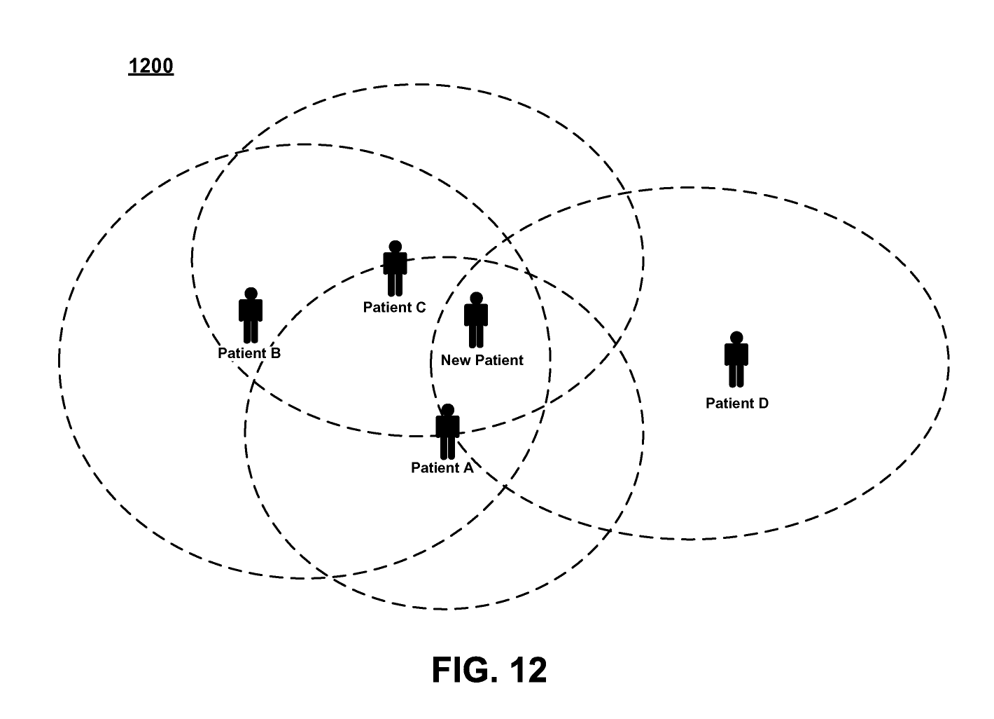

FIG. 12 depicts an embodiment of medical system environment 1200. Medical system environment 1200 includes patients A-D. However, any number of patients can be included in medical system environment 1200.

In general, when a device is associated to a patient area network or a device cluster, it is important for a clinician to easily recognize devices that are associated with one another, as described above. Various means of selecting visual indications are possible. For example, an enterprise system includes a set color scheme based on patient ID or a patient ID is used as a seed.

In one embodiment, visual indication is done by a modifiable visual identifier or profile on each device. In such an embodiment, color and/or patterns are utilized on the display of the devices. However, other visual means such as LED's can be utilized to identify association. In various embodiments, colors and/or patterns are applied to the background of the display or to a dedicated area, such as a tile bar.

When a new patient area network or device cluster is created, the device initiating the cluster scans for devices in the proximity, and retrieve identifiers (e.g., visual identifiers of color and/or patterns) used to identify nearby clusters. The device then analyzes the received information, and selects a color and pattern combination that is least likely to overlap with nearby patient area networks or clusters. The discovery process is achieved in the same fashion as described above.

For example, a patient area network associated with Patient A utilizes the color blue to identify the devices associated with Patient A. Similarly, a patient area network associated with Patient B utilizes the color yellow, a patient area network associated with Patient C utilizes the color green, and a patient area network associated with Patient D utilizes the color red.

A device associated with New Patient scans its proximity. Referring to FIG. 1, the medical device utilizes device discoverer 120 to discover all of the devices within proximity to New Patient. Additionally, identifier retriever 125 retrieves the visual identifiers of the discovered medical devices.

The medical device then creates a list of visual identifiers based on the results from the discovery. Table 3 below depicts an embodiment of the list of visual identifiers based on the results of the discovery.

| Patient | Visual | Proximity |
|---|---|---|
| Network | Identifier | Estimate |
| Patient C | Green | 60 |
| Patient A | Blue | 40 |
| Patient B | Yellow | 25 |
| Patient D | Red | 10 |

The medical device then picks the color red for the new patient area network because red is the color that is least likely to overlap with the new patient area network.

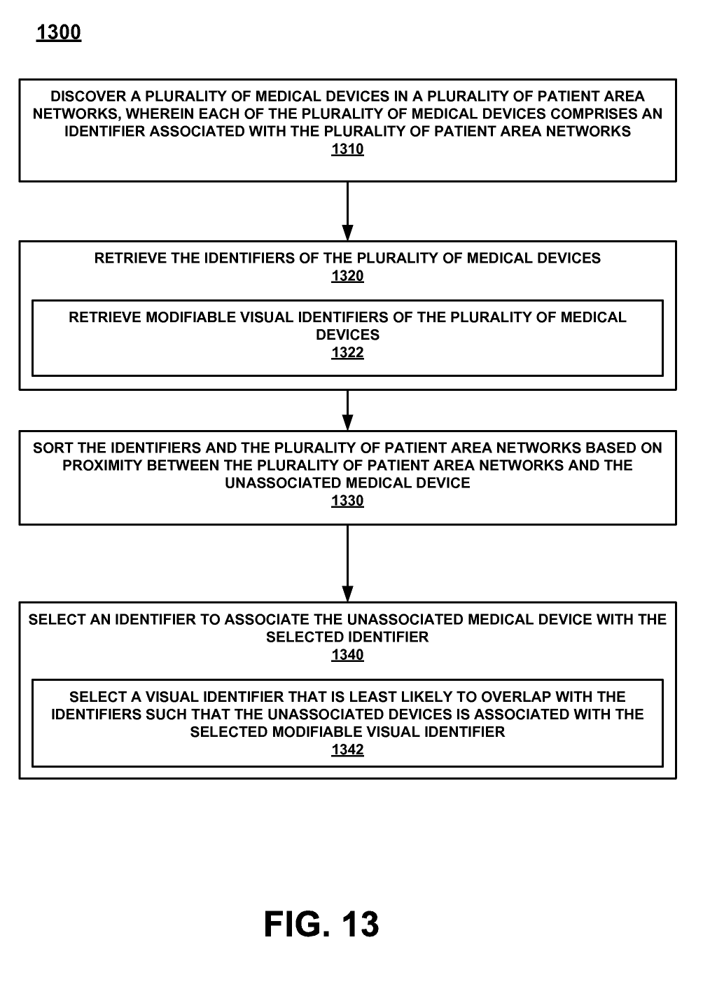

FIG. 13 depicts an embodiment of a method 1300 for visually recognizing associated medical devices. In various embodiments, method 1000 is carried out by processors and electrical components under the control of computer readable and computer executable instructions. The computer readable and computer executable instructions reside, for example, in a data storage medium such as computer usable volatile and non-volatile memory. However, the computer readable and computer executable instructions may reside in any type of computer readable storage medium. In some embodiments, method 1300 is performed at least by medical device 110 and 910, as described in FIGS. 1 and 9, respectively.

At 1310, a plurality of medical devices in a plurality of patient area networks are discovered, wherein each of the plurality of medical devices comprises an identifier associated with the plurality of patient area networks. For example, a medical device associated with a new patient discovers a plurality of patient networks associated with Patients A-D, as depicted in FIG. 12.

At 1320, the identifiers of the plurality of medical devices are retrieved. In one embodiment, at 1322, modifiable visual identifiers (e.g., color and/or patterns) of the plurality of medical devices are retrieved.

At 1330, the identifiers and the plurality of patient area networks are sorted based on proximity between the plurality of patient area networks and the unassociated medical device.

At 1340, an identifier is selected to associate the unassociated medical device with the selected identifier. In one embodiment, at 1042, a visual identifier that is least likely to overlap with the identifiers is selected such that the unassociated devices are associated with the selected modifiable visual identifier.

Various embodiments of the present invention are thus described. While the present invention has been described in particular embodiments, it should be appreciated that the present invention should not be construed as limited by such embodiments, but rather construed according to the following claims.

1. A method for managing a plurality of associated medical devices, said method comprising:
determining an association between a plurality of medical devices in a wireless network environment; and
displaying a visual profile indicating said association between said plurality of medical devices.

2. The method of claim 1, wherein said determining an association between a plurality of medical devices in a wireless network environment further comprises:
determining whether a plurality of medical devices comprise a medical device cluster.

3. The method of claim 1, further comprising:
in response to user input, associating said plurality of medical devices.

4. The method of claim 1, further comprising:
automatically associating said plurality of medical devices.

5. The method of claim 1, further comprising:
configuring properties of said visual profile.

6. The method of claim 1, wherein said displaying a visual profile further comprises:
displaying said visual profile on at least one of said medical devices.

7. The method of claim 1, wherein said displaying a visual profile further comprises:
displaying a visual profile indicating a change of said association between said plurality of medical devices.

8. The method of claim 1, wherein said displaying a visual profile further comprises:
dynamically displaying a visual profile indicating a change of state of at least one of said plurality of medical devices.

9. The method of claim 1, further comprising:
determining a second association between a subset of said plurality of devices.

10. The method of claim 9, further comprising:
displaying a second visual profile indicating said second association between said subset of said plurality of devices.

11. The method of claim 1, further comprising:
dissolving said association between said plurality of medical devices.

12. A system for managing a plurality of associated medical devices, said device comprising:
an association determiner configured for determining an association between a plurality of medical devices in a wireless network environment; and
a display configured for displaying a visual profile indicating said association between said plurality of medical devices.

13. The system of claim 12, further comprising:
a device associator configured for generating said association between said plurality of medical devices.

14. The system of claim 13, wherein said device associator is further configured for generating said plurality of medical devices in response to user input.

15. The system of claim 13, wherein said device associator is further configured for automatically generating said association between said plurality of medical devices.

16. The system of claim 12, wherein said display is selected from a group consisting of: a liquid crystal display (LCD) and a light emitting diode (LED).

17. The system of claim 16, wherein said display is disposed on at least one of said plurality of medical devices.

18. The system of claim 12, wherein said plurality of said medical devices comprise a first medical device cluster.

19. The system of claim 18, wherein at least two of said plurality of medical devices comprise a second medical device cluster within said first medical device cluster.

20. The system of claim 19, wherein said first medical device cluster is independent of said second medical device cluster.

21. A method for visually recognizing associated medical devices, said method comprising:
discovering a plurality of medical devices in a plurality of patient area networks, wherein each of said plurality of medical devices comprises an identifier associated with said plurality of patient area networks;
retrieving said identifiers of said plurality of medical devices;
sorting said identifiers and said plurality of patient area networks based on proximity between said plurality of patient area networks and said unassociated medical device; and
selecting an identifier to associate said unassociated medical device with said selected identifier.

22. The method of claim 21, wherein said retrieving said identifiers of said plurality of medical devices comprises:
retrieving modifiable visual identifiers of said plurality of medical devices.

23. The method of claim 21, wherein said selecting an identifier of said identifiers to associate said unassociated medical device with said selected identifier comprises:
selecting a visual identifier that is least likely to overlap with said identifiers such that said unassociated devices are associated with said selected modifiable visual identifier.

24. The method of claim 21, wherein said selecting a visual identifier comprises:
selecting a visual identifier from a group consisting of: color and pattern.
